(19) United States
(12) Patent Application Publication
(10) Pub. No.: US 2015/0014069 A1
(43) Pub. Date: Jan. 15, 2015

(54) SCANNING TABLE

(71) Applicant: Shenyang Neusoft Medical Systems Co., Ltd, Shenyang (CN)

(72) Inventors: Jun YU, Shenyang (CN); Yanjie CAO, Shenyang (CN)

(73) Assignee: Shenyang Neusoft Medical Systems Co., Ltd., Shenyang (CN)

(21) Appl. No.: 14/142,961

(22) Filed: Dec. 30, 2013

(30) Foreign Application Priority Data
Jul. 10, 2013 (CN) 201310289355.2

(51) Int. Cl. G01G 19/52; A61G 13/10; G01G 19/44

(52) U.S. Cl. CPC G01G 19/52; G01G 19/445; A61G 13/10
USPC 177/144

(57) ABSTRACT

A scanning table is provided to measure a patient's weight accurately. The scanning table may include a table body, for supporting a human body; a lifting system, for driving the table body to go up and down; and a force-measuring component connected with the lifting system, for measuring a support force which is imposed on the table body by the lifting system. Because the support force to the table body by the lifting system is related to positions of a patient and the table body. When the lifting system is connected with the force-measuring component, a force measured by the force-measuring component can reflect the patient's weight accurately and truly. The force-measuring component can measure a change of the support force, which is combined with related data of the table body to obtain the patient's weight. Therefore, the measurement accuracy can be improved.

### CROSS REFERENCE TO RELATED APPLICATIONS

The present application claims priority to Chinese patent application No. 201310289355.2, filed on Jul. 10, 2013, and entitled “Scanning Table”, the entire disclosure of which is incorporated herein by reference.

### TECHNICAL FIELD

The present disclosure generally relates to medical machinery, and more particularly, to a scanning table which is capable of measuring a patient's weight.

### BACKGROUND

Generally, in the working process of a large medical imaging diagnostic equipment, a patient's weight is of important reference value in many respects, such as arrangement for subsequent scanning and measuring, and determination of an intervening relationship between movements of a scanning table and movements of other components. However, the conventional large medical equipments, for example, a scanning table, also known as a patient table, a scanning support table (referred to as scanning table in the present description) used in Computed Tomography (CT). Magnetic Resonance Imaging (MRI) and Positron Emission Tomography/Computed Tomography (PET/CT) have no function of weighing.

In existing technology, a hospital bed capable of weighing is mainly designed for disabled patients, which has simple functions of weighing to monitor a patient's weight change during nursing.

More information may refer to Chinese patent application No. 200720175287.7, which discloses a hospital bed capable of weighing. To implement weighing, one or two dynamometers are mounted on a component for supporting a human body of the conventional hospital bed. For example, a dynamometer may be mounted on a bed cradle or a support point of a bed board. A patient's body weight may be obtained by reading the dynamometer vertical component forces and accumulating the forces.

In operation, a bed board of a scanning table generally needs to move to different positions along a horizontal direction. Different patients lie on the scanning table at different positions. Accordingly, despite that a patient's weight can be measured by a dynamometer mounted on a bed cradle or at a support point of a bed board, the measurement result may be inaccurate due to complexity of human body's position, bed board's position, and deformation of the bed board in suspending. In addition, for the purpose of movement, there are lots of hinge joints configured on a scanning table between a bed cradle and a support component. Forces imposed on the hinge joints may change when the scanning table moves to different positions. So, it requires more than two dynamometers to be mounted on the bed cradle or the support point of the bed board, which in turn increases complexity of the measuring structure.

Therefore, there is a need to provide a scanning table which is capable of accurately measuring a patient's weight.

### SUMMARY

Embodiments of the present disclosure provide a scanning table which is capable of accurately measuring a patient's weight.

In one embodiment, a scanning table is provided, which may include: a table body, for supporting a human body; a lifting system, for driving the table body to go up and down; and a force-measuring component connected with the lifting system, for measuring a support force on the table body by the lifting system.

According to the scanning table provided in the present disclosure, the force-measuring component is connected with the lifting system. When the lifting system drives the table body to go up and down, the table body may be supported at a certain position. The force-measuring component may sense in real-time the support force imposed on the table body by the lifting system, thus the patient's weight can be obtained by computation. Because the support force to the table body by the lifting system is related to positions of a patient and the table body. When the lifting system is connected with the force-measuring component, a force measured by the force-measuring component can reflect the patient's weight accurately and truly. No matter which position the patient lies on the table body, which height the table body locates, and which position the table body lies horizontally, the force-measuring component can detect a change of the support force, which is combined with related data of the table body to obtain the patient's weight.

In some embodiments, the scanning table further comprises a bed base, and the lifting system comprises a first swinging pole, a second swinging pole and a driving support pole, wherein one end of both the first swinging pole and the second swinging pole are hinged to the table body, the first swinging pole and the second swinging pole are disposed in parallel, the other end of both the first swinging pole and the second swinging pole are fixedly connected with the bed base, a telescopic end of the driving support pole is hinged to one of the first swinging pole and the second swinging pole, and a fixed end of the driving support pole is fixedly connected with the bed base and is connected with the force-measuring component.

In some embodiments, the force-measuring component is a hinge-pin force transducer which is hinged to the fixed end of the driving support pole, wherein the hinge-pin force transducer comprises a strain gauge, the axis line of the driving support pole is perpendicular to the strain gauge, and a hinge pin of the force-measuring component can be driven to rotate with the swinging of the driving support pole.

In some embodiments, the force-measuring component may be a hinge-pin force transducer which is hinged to the driving support pole. When the driving support pole drives the first swinging pole and the second swinging pole to swing, the hinge pin of the force-measuring component can be driven to rotate with the swinging. And the axis line of the driving support pole is perpendicular to the strain gauge. Thus, the strain gauge will deform to fulfill the measurement of the support force.

In some embodiments, the scanning table further comprises an U-shaped groove and a base disposed on the bed base, wherein the fixed end of the driving support pole is engaged to the U-shaped groove, so that the U-shaped groove is stuck to the driving support pole; the base and the U-shaped groove are provided with a first pin hole and a second pin hole, respectively, wherein the hinge pin of the force-measuring component extends through the driving support pole, the first pin hole and the second pin hole, and is fixedly connected with the U-shaped groove.

The force-measuring component may move with the driving support pole through the U-shaped groove. Both ends of the force-measuring component are connected fixedly to two sidewalls of the U-shaped groove, respectively, and the U-shaped groove is stuck to the driving support pole, such that the driving support pole can be connected with the force-measuring component without changing the driving support pole. In this way, the driving support pole can be protected without affecting its strength, which may guarantee the driving's effectiveness. Further, the U-shaped groove is stuck to the driving support pole, which may restrict the driving support pole to move right and left or waggle front and back, and increase reliability of positioning.

In some embodiments, the scanning table may further include a clamp disposed on each side of the U-shaped groove, and each side of the hinge pin of the force-measuring component is provided with a bayonet, wherein the clamp is jammed in the bayonet.

In some embodiments, the force-measuring component is a cantilever force transducer or a S-shaped force transducer, which is hinged to the fixed end of the driving support pole, wherein both the cantilever force transducer and the S-shaped force transducer comprise a strain gauge, and the axis line of the driving support pole is perpendicular to the strain gauge of the force-measuring component.

In some embodiments, the force-measuring component is hinged to the driving support pole through a pole-end-bearing.

When the force-measuring component is a cantilever force transducer or a S-shaped force transducer, it can be hinged to the driving support pole through the pole-end-bearing. As such, the support force can be measured according to the force imposed on the strain gauge by the driving support pole. The force-measuring component provided in embodiments of the present disclosure has a simple structure and a high precision.

In some embodiments, the force-measuring component is a strain gauge which is disposed integrated with the driving support pole.

Because the force-measuring component can be integrated with the driving support pole, there is no need for special force-measuring apparatus, which may simplify the structure of the scanning table, and save a tedious process for assembling the special force-measuring apparatus.

In some embodiments, the scanning table comprises a bed base and a lifting system comprising a first fulcrum pole, a second fulcrum pole and a driving lead screw, wherein the first fulcrum pole is hinged crosswise to the second fulcrum pole, one end of both the first fulcrum pole and the second fulcrum pole are hinged to the bed base, one of the other end of the first fulcrum pole and the second fulcrum pole is connected with the driving lead screw through screw connection, the remaining end of the first fulcrum pole or the second fulcrum pole is connected fixedly to the bed base, and the driving lead screw is connected with the force-measuring component.

According to the above embodiments, the supporting structure of the lifting system includes the first fulcrum pole and the second fulcrum pole which are hinged crosswise each other, and the driving structure of the lifting system includes the driving lead screw which is connected with one of the first fulcrum pole and the second fulcrum pole through screw connection. The driving lead screw is connected with the force-measuring component. When the driving lead screw rotates, the force-measuring component may sense the change of driving force in real-time.

In some embodiments, the scanning table further comprises a transmitter communicatively connected to the force-measuring component and a display communicatively connected to the transmitter.

The scanning table provided in embodiments of the present disclosure may be provided with the transmitter and the display. Therefore, it is convenient and visualized that the measured result can be displayed by signal transformation.

In some embodiments, the scanning table further comprises a computation device, wherein the computation device is communicatively connected to the force-measuring component, so that a patient's weight can be calculated according to a support force measured by the force-measuring component, and the computation device is communicatively connected to the display.

When the computation device is provided, the patient's weight can be calculated by the computer module and displayed through the display, which makes the measurement visualized.

### BRIEF DESCRIPTION OF THE DRAWINGS

FIG. 1 schematically illustrates a structural perspective view of a scanning table according to a first embodiment of the present disclosure;

FIG. 2 schematically illustrates a partial exploded view of a force-measuring component and a driving support pole shown in FIG. 1;

FIG. 3 schematically illustrates a partial enlarged view of the force-measuring component shown in FIG. 2;

FIG. 4 schematically illustrates an assembly view of a force-measuring component and a driving support pole shown in FIG. 2;

FIG. 5 schematically illustrates a partial exploded view of a force-measuring component and a driving support pole according to a second embodiment of the present disclosure;

FIG. 6 schematically illustrates an assembly view of a force-measuring component and a driving support pole shown in FIG. 5;

FIG. 7 schematically illustrates a partial exploded view of a force-measuring component and a driving support pole according to a third embodiment of the present disclosure;

FIG. 8 schematically illustrates an assembly view of a force-measuring component and a driving support pole shown in FIG. 7;

FIG. 9 schematically illustrates a partial enlarged view of a force-measuring component and a driving support pole according to a fourth embodiment of the present disclosure;

FIG. 10 schematically illustrates a principle of body weight measurement according to the four embodiments described above;

FIG. 11 is a schematic block view of data transformation of body weight measurement according to the four embodiments described above;

FIG. 12 schematically illustrates a structural perspective view of a scanning table according to a fifth embodiment of the present disclosure;

FIG. 13 schematically illustrates a partial exploded view of a force-measuring component and a driving lead screw shown in FIG. 12;

FIG. 14 schematically illustrates an assembly view of a force-measuring component and a driving lead screw shown in FIG. 13;

FIG. 15 schematically illustrates a principle of body weight measurement according to the fifth embodiment of the present disclosure;

FIG. 16 is a schematic structural view of the principle of body weight measurement shown in FIG. 15; and

FIG. 17 is a block view schematically illustrating data transformation of body weight measurement according to the fifth embodiment of the present disclosure.

Reference numeral: 1—table body; 2—lifting system; 21—first swinging pole; 22—second swinging pole; 23—driving support pole; 24—first fulcrum pole; 25—second fulcrum pole; 26—driving lead screw; 261—spheric joint having a screw; 27—photoelectric encoder; 28—cord-pull sensor; 3—force-measuring component; 31—bayonet; 32—strain hole; 4—base; 41—first pin hole; 42—gland-cover; 5—U-shaped groove; 51—second pin hole; 6—clamp; 7—pole-end-bearing; 8—transmitter; 9—display; and 10—bed base.

### DETAILED DESCRIPTION

Embodiments of the present disclosure provide a scanning table which is capable of accurately measuring a patient's weight.

In order to clarify the objects, characteristics and advantages of the disclosure, the embodiments of the present disclosure will be described in detail in conjunction with the accompanying drawings.

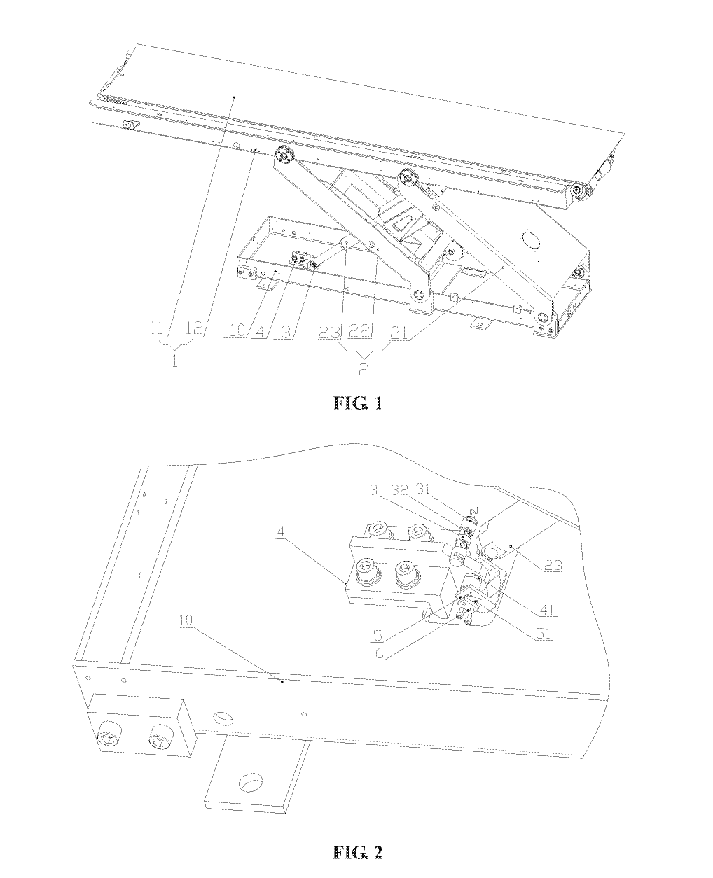

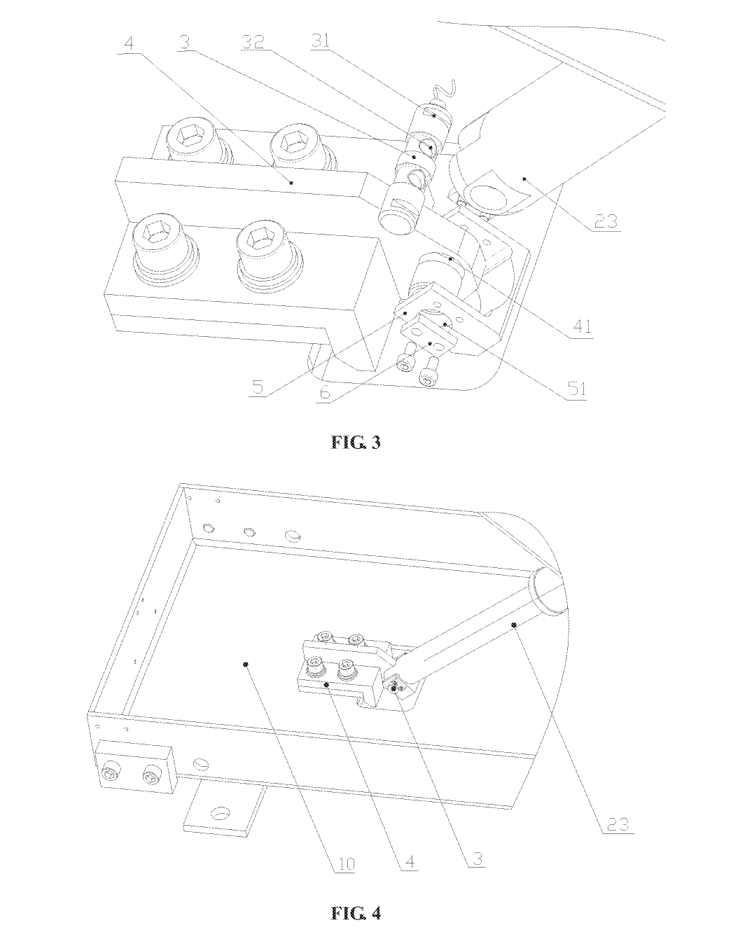

Referring to FIG. 1 to FIG. 4, FIG. 1 schematically illustrates a structural perspective view of a scanning table according to a first embodiment of the present disclosure, FIG. 2 schematically illustrates a partial exploded view of a force-measuring component and a driving support pole shown in FIG. 1, FIG. 3 schematically illustrates a partial enlarged view of the force-measuring component shown in FIG. 2, and FIG. 4 schematically illustrates an assembly view of a force-measuring component and a driving support pole shown in FIG. 2.

The scanning table provided in the present disclosure may include a table body 1 for supporting a human body, and a lifting system 2 for driving the table body 1 to rise and fall. The lifting system 2 may meet scanning requirements with the capability of changing the table body's position. In some embodiments, the scanning table may further include a force-measuring component 3 connected with the lifting system 2. The force-measuring component 3 can measure a support force imposed on the table body 1 by the lifting system 2. There is a correlation between the support force imposed on the table body 1 by the lifting system 2 and a patient's weight supported by the table body 1, which thus may be used to obtain the patient's weight.

When the lifting system 2 supports the table body 1, the table body 1 supports a patient's weight. In turn, the table body 1 applies pressure to the lifting system 2, and the lifting system 2 transmits the pressure to the force-measuring component 3. Therefore, the force-measuring component 3 may measure the force imposed on the lifting system 2. i.e., the support force imposed on the table body 1 by the lifting system 2.

There exists a certain relationship between a driving force imposed on the table body 1 by the lifting system 2 and a total support force imposed on the table body 1. In other words, the weight change of the table body 1 may be reflected by the driving force applied by the lifting system 2. Therefore, no matter what position the lifting system 2 drives the table body 1 to move to or no matter what height the lifting system 2 lifts the table body 1 to, the force-measuring component 3 may accurately obtain the patient's weight since the force-measuring component 3 is connected with the lifting system 2.

Specifically, the table body 1 may further include a bed cradle 12 and a bed board 11 for carrying a patient and disposed on the bed cradle 12. The bed board 11 may be provided with a structure which can be pulled out horizontally, or a sliding component, such as a roller, such that the bed board 11 can move horizontally relative to the bed cradle 12 and thus a horizontal position where the patient lies on the scanning table may be changed. The lifting system 2 is connected with the bed cradle 12, such that a height of the scanning table can be adjusted by lifting.

The bed cradle 12 serves as a support for the bed board 11 when they are connected together. The bed cradle 12 is further connected with the lifting system 2, and a force imposed on the bed cradle 12 can be transmitted to the lifting system 2. Accordingly, no matter what position the patient lies on the bed board 11, no matter what position the bed board 11 moves horizontally to, or what height the bed cradle 12 locates at, the force can be reflected by the force-measuring component 3 as it is connected with the lifting system 2, which thereby increases measurement accuracy.

In addition, for further improving measurement accuracy, two or more than two force-measuring components 3 may be provided at where the force passes, so as to achieve redundancy measurement. For example, a force-measuring components 3 may be mounted at where the lifting system 2 drives the table body 1 or a source of the driving force of the lifting system 2.

In some embodiments, the scanning table described above may be further improved.

In some embodiments, the scanning table may be provided with a bed base 10 which serves as a chassis positioning structure to increase stability of the table body 1. In some embodiments, the lifting system 2 may be mounted on the bed base 10. The table body 1 may be disposed parallel to the bed base 10.

### Embodiment One

Referring to FIG. 1 to FIG. 3, in the first embodiment, the scanning table includes the bed base 10. The lifting system 2 may include a first swinging pole 21, a second swinging pole 22 and a driving support pole 23, where the first swinging pole 21 is disposed parallel to the second swinging pole 22. One end of both the first swinging pole 21 and the second swinging pole 22 are hinged to the table body 1, and the other end of both the first swinging pole 21 and the second swinging pole 22 are connected fixedly with the bed base 10. The swing of the first swinging pole 21 and the second swinging pole 22 may drive the table body 1 to lift and translation. The driving support pole 23 may be designed to be a linear actuator, which has a telescopic end and a fixed end, where the telescopic end is hinged to one of the first swinging pole 21 and the second swinging pole 22, and the fixed end is fixedly connected with the bed base 10. The driving support pole 23 is connected with the force-measuring component 3 through the fixed end. Because both the first swinging pole 21 and the second swinging pole 22 are hinged to the table body 1, there is a movement interrelation between them. When the driving support pole 23 is connected with one of the first swinging pole 21 and the second swinging pole 22, both of them can be driven synchronously.

When the table body 1 is disposed parallel to the bed base 10, one end of both the first swinging pole 21 and the second swinging pole 22 may be hinged to the table body 1, and the other end of both the first swinging pole 21 and the second swinging pole 22 are hinged to the bed base 10. Thus, the first swinging pole 21, the second swinging pole 22, the table body 1 and the bed base 10 collectively form a parallelogram. In this way, the first swinging pole 21 and the second swinging pole 22 have better synchronicity in swinging.

Specifically, the force-measuring component 3 may be a hinge-pin force transducer. Referring to FIG. 2 to FIG. 4, the hinge-pin force transducer is hinged to the fixed end of the driving support pole 23 through a hinge pin. The hinge-pin force transducer may include a strain hole 32 containing a strain gauge therein. When the strain hole 32 is disposed with its axis line parallel to that of the driving support pole 23, the axis line of the driving support pole 23 is perpendicular to the strain gauge, so that the strain gauge can accurately sense a force applied by the driving support pole 23. The swing of the driving support pole 23 may drive the first swinging pole 21 and the second swinging pole 22 to swing, and thus to change the position of the table body 1. Meanwhile, the swing of the driving support pole 23 may drive the hinge pin to rotate, thus to change the position of the strain hole 32 of the force-measuring component 3, and to keep the driving support pole 23 and the strain gauge perpendicular with each other.

In addition, the scanning table provided in embodiments of the present disclosure may further include a base 4 mounted on the bed base 10 and a U-shaped groove 5 pin-joint with the base 4. The fixed end of the driving support pole 23 may be embedded in the U-shaped groove 5, so that the U-shaped groove 5 may clamp and fix the driving support pole 23. The base 4 is provided with a first pin hole 41. When assembling, the hinge pin of the force-measuring component 3 may pass through the first pin hole 41 and the driving support pole 23. Both ends of the hinge pin of the force-measuring component 3 are connected fixedly to two sidewalls of the U-shaped groove 5, respectively. In this way, the driving support pole 23 and the force-measuring component 3 are connected with each other through the hinge pin. Because both ends of the hinge pin are connected fixedly to two sidewalls of the U-shaped groove 5, the circumferential direction of the force-measuring component 3 is fixed relative to the U-shaped groove 5. Therefore, the swing of the driving support pole 23 may be transformed into the rotation of the hinge pin of the force-measuring component 3 through the U-shaped groove 5.

In some embodiments, the base 4 may be connected fixedly with the bed base 10 through screws, so as to connect the bed base 10 with the driving support pole 23, as shown in FIG. 2 to FIG. 4.

There are many ways to connect two ends of the hinge pin of the force-measuring component 3 with two sidewalls of the U-shaped groove 5. For example, two ends of the hinge pin of the force-measuring component 3 may be clamped and fixed to the two sidewalls of the U-shaped groove 5. In some embodiments, they may be fixed together by welding, or through a connector.

In a way of circumferentially fixing, the scanning table provided in embodiments of the present disclosure may further include a clamp 6 which may be disposed on each side of the U-shaped groove 5. The hinge pin of the force-measuring component 3 may be provided with a bayonet 31 on each side. The clamp 6 is adaptively jammed in the bayonet 31. A second pin hole 51 is further provided on each side of the U-shaped groove 5, through which the hinge pin of the force-measuring component 3 may pass. When assembling, two ends of the hinge pin of the force-measuring component 3 may pass through two sidewalls of the U-shaped groove 5, respectively. Then, the clamp 6 may be jammed in the bayonet 31 on each side of the hinge pin. The movement of the U-shaped groove 5 can be transmitted to the force-measuring component 3, which in turn drive the rotation of the hinge pin of the force-measuring component 3.

According to the assembling ways described above, the independence of the U-shaped groove 5 and the force-measuring component 3 may be improved. Further, it is convenient to assemble or disassemble the force-measuring component 3.

In the second to the fourth embodiments, the lifting system 2 may also include the first swinging pole 21, the second swinging pole 22 and the driving support pole 23, three of which have a connection relationship similar to that in the first embodiment, which will not be described in detail hereinafter.

### Embodiment Two

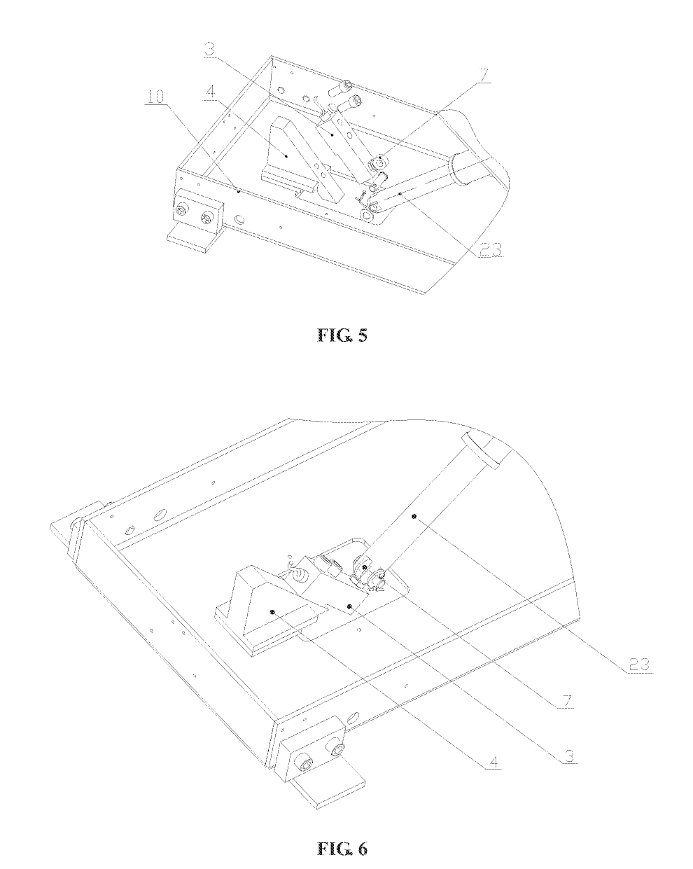

Referring to FIG. 5 and FIG. 6, FIG. 5 schematically illustrates a partial exploded view of a force-measuring component and a driving support pole shown according to the second embodiment of the present disclosure; and FIG. 6 schematically illustrates an assembly view of a force-measuring component and a driving support pole shown in FIG. 5.

In the second embodiment, the force-measuring component 3 may be a cantilever force transducer having a strain gauge. The cantilever force transducer is hinged to the fixed end of the driving support pole 23. The axis line of the driving support pole 23 is perpendicular to the strain gauge of the force-measuring component 3. A patient's weight is imposed on the driving support pole 23, which in turn is transmitted to the strain gauge of the force-measuring component 3 and deforms the strain gauge. In this way, a support force to the table body 1 can be measured.

A pole-end-bearing 7 may be provided at one end of the cantilever force transducer, the end where the strain gauge is disposed (hereinafter referred to as an induced end). And a connecting hole may be disposed on the fixed end of the driving support pole 23. The fixed end of the driving support pole 23 may be hinged to the pole-end-bearing 7 by means of a connector, such as a pin bolt. The driving support pole 23 may rotate freely around a hinged shaft, so as to drive the first swinging pole 21 and the second swinging pole 22. On the other hand, the driving support pole 23 may impose on the strain gauge of the force-measuring component 3 through the pole-end-bearing 7, so as to measure a support force.

It is known to those skilled in the art that the pole-end-bearing 7 may be connected fixedly with the force-measuring component 3 through screws. Referring to FIG. 6, the pole-end-bearing 7 may be fixed at one end of the cantilever force transducer through screw connection. Specifically, a screw may be disposed on the outer wall of the pole-end-bearing 7 along a radial direction of the pole-end-bearing 7. The pole-end-bearing 7 is then connected, along a direction perpendicular to the strain gauge of the force-measuring component 3, to the force-measuring component 3 through the screw, which in turn transmit the force of the driving support pole 23 to the strain gauge, and cause deformation to the strain gauge. Thus, the measurement accuracy can be improved.

When the force-measuring component 3 is a cantilever force transducer, the base 4 may be designed to have a bevel surface. Referring to FIG. 6, the cantilever force transducer may be fixed on the bevel surface of the base 4, which may facilitate realizing the axis line of the driving support pole 23 perpendicular to the strain gauge.

### Embodiment Three

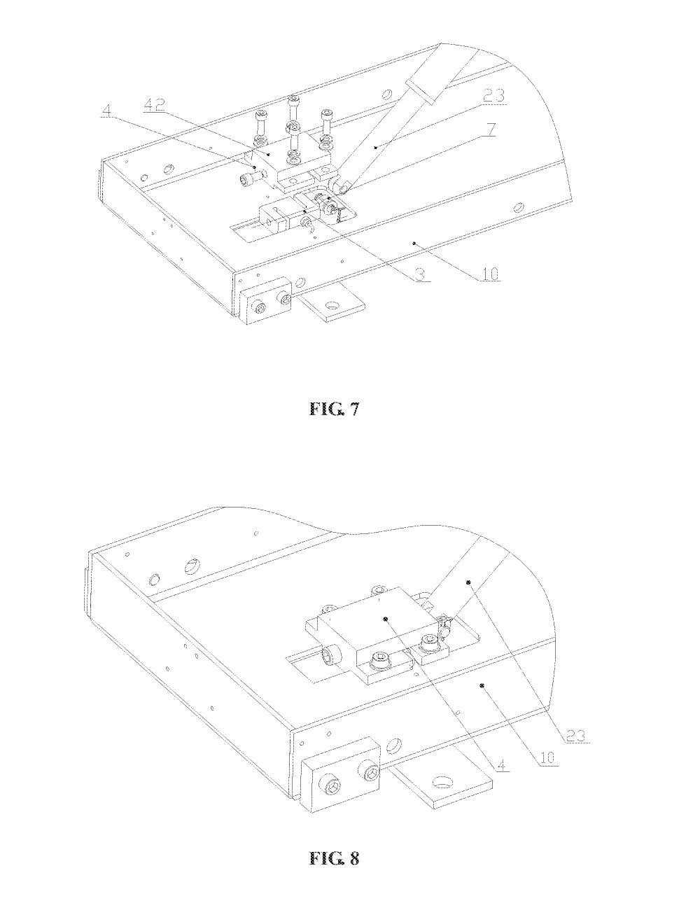

Referring to FIG. 7 and FIG. 8, FIG. 7 schematically illustrates a partial exploded view of a force-measuring component and a driving support pole shown according to the third embodiment of the present disclosure; and FIG. 8 schematically illustrates an assembly view of a force-measuring component and a driving support pole shown in FIG. 7.

In the third embodiment, the force-measuring component 3 may be an S-shaped force transducer having a strain gauge, the detailed configuration may refer to the second embodiment.

In this case, the base 4 may be designed to be a gland-cover structure. Referring to FIG. 7 and FIG. 8, the base 4 is provided with a gland-cover 42 which may be covered on the force-measuring component 3. The gland-cover 42 may be connected fixedly with the bed base 10 by a connector, such as a bolt, so that the force-measuring component 3 may be mounted vertically, as shown in FIG. 7 and FIG. 8.

### Embodiment Four

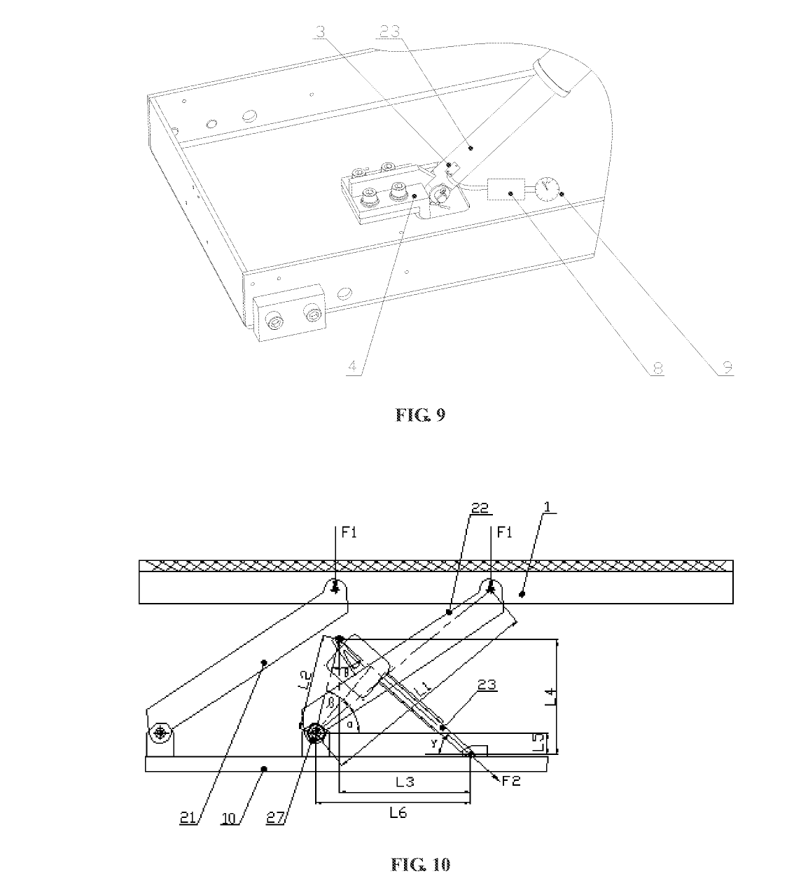

Referring to FIG. 9, FIG. 9 schematically illustrates a partial enlarged view of a force-measuring component and a driving support pole shown according to the fourth embodiment of the present disclosure.

In the fourth embodiment, the force-measuring component 3 may be integrated on the driving support pole 23. Referring to FIG. 9, the driving support pole 23 may be provided with a strain gauge as the force-measuring component 3. For example, the strain gauge may be attached directly on the driving support pole 23. When the table body 1 imposes pressure on the driving support pole 23, the driving support pole 23 deforms due to the pressure, so does the strain gauge. Thus, a support force by the driving support pole 23 can be measured.

In some embodiments, the scanning table may be provided with a transmitter 8 communicatively connected with the strain gauge and a display 9 communicatively connected with the transmitter 8. The strain gauge may transform a force signal into an analog signal and transmit to an input of the transmitter 8. The transmitter 8 may further transmit the analog signal to the display 9 for displaying, so that a support force can be read directly.

The communicative connection may be a wired or wireless connection to achieve signal transmission.

In some embodiments, the transmitter 8 may be connected with a signal converter. First, the transmitter 8 transforms a support force measured by the force-measuring component 3 into a voltage signal, which is then converted into a digital signal by the signal converter. The digital signal is transmitted to the display 9 for displaying.

In addition, the scanning table may further include a computation device, which is communicatively connected with the force-measuring component 3 and the display 9. The computation device calculates a patient's weight by using a support force measured by the force-measuring component 3 as original data, combined with other related parameters of the scanning table. The value of the patient's weight is transmitted to the display 9 for displaying, so that the patient's weight can be read directly.

In some embodiments, a transmitter 8 and a display 9 may also be provided in the first, second and third embodiments. The transmitter 8 is communicatively connected with the force-measuring component 3, so that the support force can be read directly. In some embodiments, a computation device may be provided as well, so that the patient's weight can be read directly.

In the four embodiments described above, when a support force to the table body 1 by the driving support pole 23 is obtained, a patient's weight may be obtained according to other related parameters.

Referring to FIG. 10 and FIG. 11, FIG. 10 schematically illustrates a principle of body weight measurement according to the four embodiments described above, and FIG. 11 is a schematic block view of data transformation of body weight measurement according to the four embodiments described above.

It should be noted that the computation process described below can be implemented by the computation device mentioned above. In some embodiments, a measuring component may be provided to measure angle or length. The measuring component may be connected with the signal converter, so that the measured value may be converted into a digital signal adaptive for the computation device.

Specifically, parameters of the scanning table provided in embodiments of the present disclosure will be defined as follows.

α represents an angle between a straight line connecting upper and lower supporting points of the second swinging pole 22 and the horizontal plane;

β represents an angle between a straight line connecting upper and lower supporting points of the second swinging pole 22 and a straight line connecting an upper supporting point of the driving support pole 23 and a lower supporting point of the second swinging pole 22;

θ represents an angle between the driving support pole 23 and a straight line connecting an upper supporting point of the driving support pole 23 and a lower supporting point of the second swinging pole 22;

γ represents an angle between the driving support pole 23 and the horizontal line;

L1 represents a length of a straight line connecting upper and lower supporting points of the second swinging pole 22;

L2 represents a length of a straight line connecting an upper supporting point of the driving support pole 23 and a lower supporting point of the second swinging pole 22;

L3 represents a horizontal distance between upper and lower supporting points of the driving support pole 23;

L4 represents a vertical distance between upper and lower supporting points of the driving support pole 23;

L5 represents a vertical distance between a lower supporting point of the driving support pole 23 and a lower supporting point of the second swinging pole 22;

L6 represents a horizontal distance between a lower supporting point of the driving support pole 23 and a lower supporting point of the second swinging pole 22;

F1 represents a force which is imposed on upper supporting points of the first swinging pole 21 and the second swinging pole 22 by a collective weight of a patient and the table body 1;

F2 represents a support force (which is measured in real time by means of a force-measuring component 3);

M1 represents a patient's load;

M2 represents a weight of the table body 1;

M3 represents a weight of the first swinging pole 21; and

M4 represents a weight of the second swinging pole 22.

When F2 is obtained by the force-measuring component 3, the patient's weight may be obtained by computation as follows.

The horizontal distance between upper and lower supporting points of the driving support pole 23 can be obtained according to Equation (1):

L3=L6−cos(β+α)×L2 Equation (1)

The vertical distance between upper and lower supporting points of the driving support pole 23 can be obtained according to Equation (2):

L4−sin(β+α)×L2+L5 Equation (2)

The angle between the driving support pole 23 and the horizontal plane can be obtained according to Equation (3):

$$γ = arctan \frac{L 4}{L 2} \qquad Equation ( 3 )$$

The angle between the driving support pole 23 and a straight line connecting an upper supporting point of the driving support pole 23 and a lower supporting point of the second swinging pole 22 can be obtained according to Equation (4):

θ=180°−γ−α−β Equation (4)

A relationship may be obtained according to moment balance, which is expressed as follows:

$$\begin{matrix}F 1 \times L 1 \times cos α = F 2 \times L 2 \times sin θ \\ where & Equation ( 5 ) \\ F 1 = \frac{( 2 \times ( M 1 + M 2 ) + M 3 + M 4 ) \times 9.8}{2} & Equation ( 6 )\end{matrix}$$

Accordingly, the Equation (5) may be expressed as:

$$\frac{( 2 \times ( M 1 + M 2 ) + M 3 + M 4 ) \times 9.8}{2} = \frac{F 2 \times L 2 \times sin θ}{L \text{?} \times cos α} \\ \text{?} \text{indicates text missing or illegible when filed} \qquad Equation ( 7 )$$

The patient's load may be obtained by Equation (8):

$$M 1 = \frac{\frac{\text{?} \times \text{?} \text{?} \times \text{?} \text{?} \times sin \text{?}}{L 1 \times cos α \times \text{?} \text{?}} - M 3 - M 4}{2} - M 2 \\ \text{?} \text{indicates text missing or illegible when filed} \qquad Equation ( 8 )$$

The Equation (8) may be simplified to obtain Equation (9):

$$M 1 = \frac{F 2 \times L 2 \times sin θ}{L \text{?} \times cos α \times 9.8} - \frac{M 3 + M 4}{2} - M 2 \\ \text{?} \text{indicates text missing or illegible when filed} \qquad Equation ( 9 )$$

In addition, as shown in FIG. 10, the scanning table may be further provided with a photoelectric encoder 27 which may be disposed at a hinge joint between the second swinging pole 22 and the bed base 10, so that the angle α between the second swinging pole 22 and the horizontal plane can be measured. Similarly, photoelectric encoders 27 may be disposed at other points where an angle needs to be measured. In some embodiments, other angle measure device may be used to substitute for the photoelectric encoder 27.

Referring to FIG. 11, in a process of computation, a digital signal measured by the photoelectric encoder 27 and the force-measuring component 3 is transmitted to the computation device 1. Corresponding values a and F2 may be obtained by the computation device 1 through conversion. The two values are transmitted to the computation device 2. After the computation device 2 obtains related data, the patient's load M1 may be obtained according to Equations 1-9 described above, which is then transmitted to the display 9 for displaying. The patient's load M1 may also be transmitted to a controller for further use.

### Embodiment Five

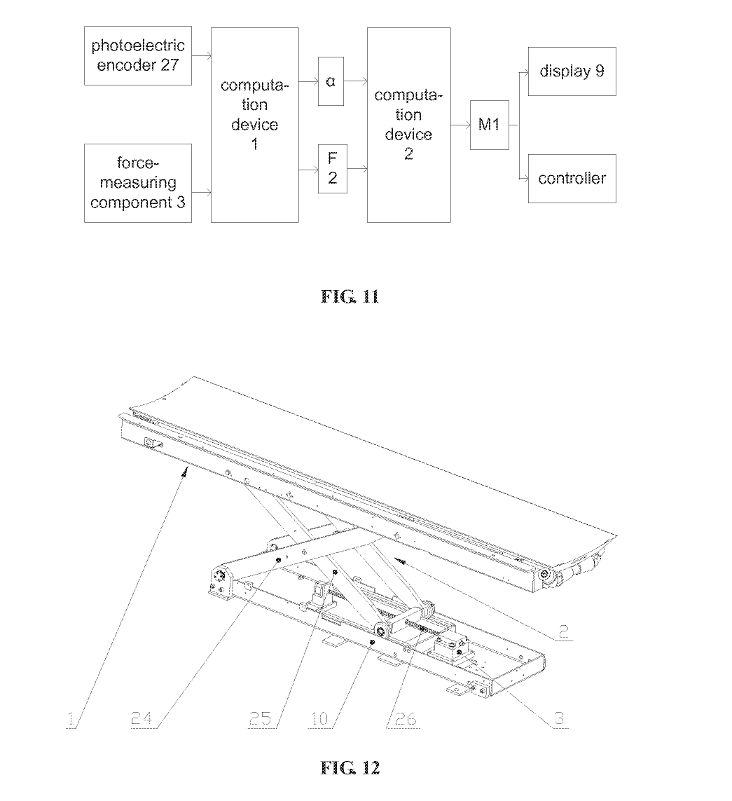

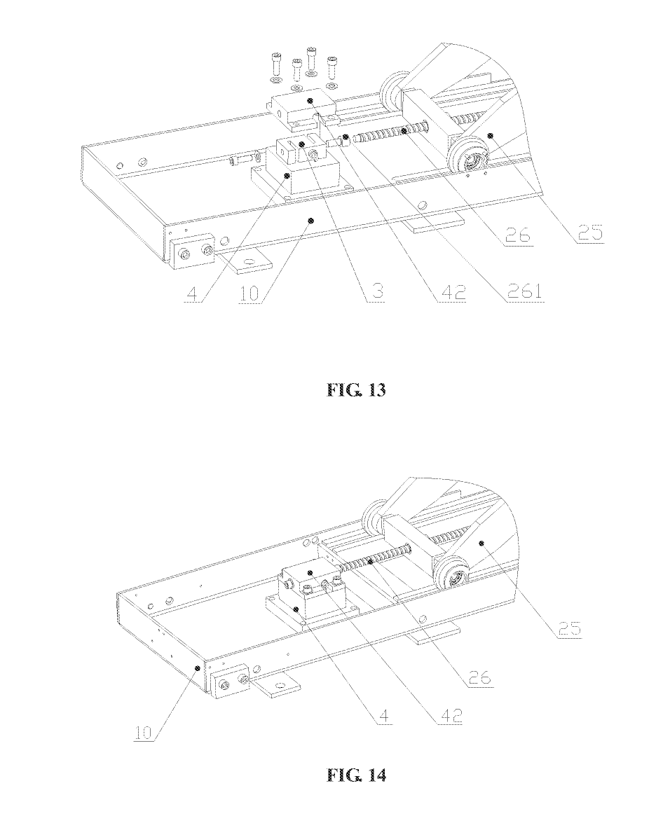

Referring to FIG. 12 to FIG. 14. FIG. 12 schematically illustrates a structural perspective view of a scanning table according to the fifth embodiment of the present disclosure, FIG. 13 schematically illustrates a partial exploded view of a force-measuring component and a driving lead screw shown in FIG. 12, and FIG. 14 schematically illustrates an assembly view of a force-measuring component and a driving lead screw shown in FIG. 13.

In the fifth embodiment, the scanning table may include a bed base 10 and a lifting system 2 including a first fulcrum pole 24, a second fulcrum pole 25 and a driving lead screw 26. The first fulcrum pole 24 and the second fulcrum pole 25 are hinged crosswise. One end of the first fulcrum pole 24 and the second fulcrum pole 25 are hinged to the bed base 10. One of the other end of the first fulcrum pole 24 and the second fulcrum pole 25 is connected with the driving lead screw 26 through bolt connection. The remaining end of the first fulcrum pole 24 or the second fulcrum pole 25 is connected fixedly with the bed base 10. The driving lead screw 26 is connected with the force-measuring component 3.

When the first fulcrum pole 24 and the second fulcrum pole 25 are hinged crosswise, the scanning table has a cross type structure. Referring to FIG. 12, the driving lead screw 26 may be used to drive the scanning table by transforming the rotation of the driving lead screw 26 into the swinging of the first fulcrum pole 24 and the second fulcrum pole 25.

For example, the other end of the second fulcrum pole 25 is connected with the driving lead screw 26, as shown in FIG. 12 to FIG. 14. When the driving lead screw 26 rotates, the second fulcrum pole 25 is driven to move along the axis of the driving lead screw 26, which in turn drives the first fulcrum pole 24 and the second fulcrum pole 25 to swing, and thus the table body 1 to go up and down.

In some embodiments, a force-measuring component 3 may be connected with one end of the driving lead screw 26, as shown in FIG. 13 and FIG. 14. The end of the force-measuring component 3 on which a strain gauge is disposed is called as an induced end. A spheric joint 261 having a screw may be connected with one end of the driving lead screw 26. The spheric joint 261 is connected with the force-measuring component 3 through the screw, so that the force-measuring component 3 can timely sense a driving force and a support force to the table body 1 by the driving lead screw 26.

In some embodiments, the force-measuring component 3 may be a hinge-pin force transducer, a cantilever force transducer or an S-shaped force transducer. The configuration relationship between the force-measuring component 3 and the driving lead screw 26 may refer to the first to the fourth embodiments, so that a driving support force to the table body 1 by the driving lead screw 26 can be measured. In some embodiments, a base 4 may be provided referring to the first to the fourth embodiments, so as to fulfill the assembling of the force-measuring component 3.

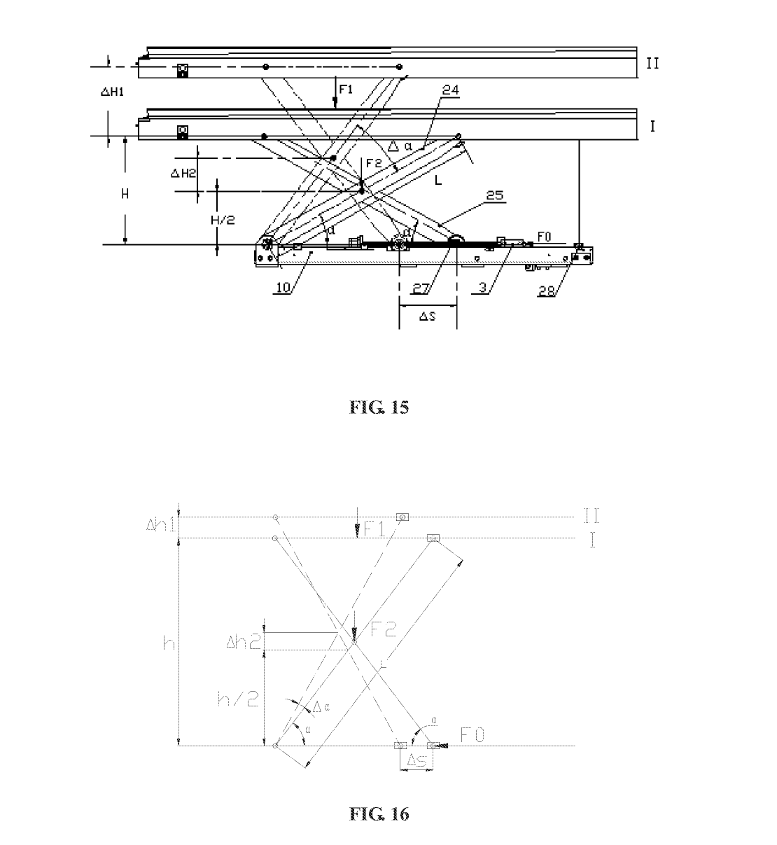

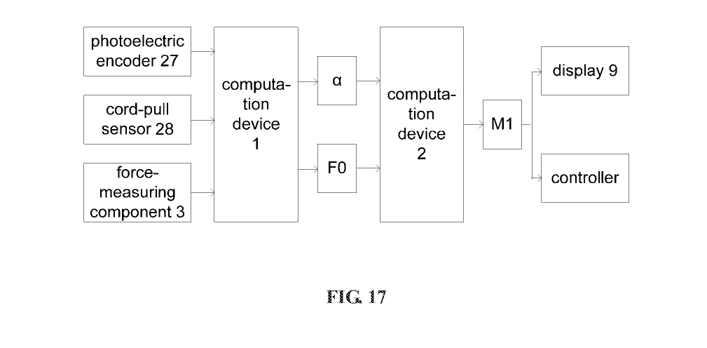

Referring to FIG. 15 to FIG. 17, FIG. 15 schematically illustrates a principle of body weight measurement according to the fifth embodiment of the present disclosure. FIG. 16 is a simple structural view schematically illustrating the principle of body weight measurement shown in FIG. 15, and FIG. 17 is a block view schematically illustrating data transformation of body weight measurement according to the fifth embodiment of the present disclosure.

In the fifth embodiment, parameters are defined as follows:

I represents a position where the table body 1 locates at a certain height;

II represents a position having an infinitesimal displacement based on I position;

α represents an angle between a straight line connecting upper and lower supporting points of the second fulcrum pole 25 and the horizontal plane;

F0 represents a driving force imposed on the lower end of the second fulcrum pole 25 (which is measured in real time by means of the force-measuring component 3)

F1 represents a collective weight of a patient and the table body 1;

F2 represents a force imposed at a hinge joint point O by a weight of the first fulcrum pole and the second fulcrum pole;

O represents a hinge joint point of the first fulcrum pole and the second fulcrum pole;

h represents a height of the table body 1 where the table body 1 locates at I position;

L represents a length of the first fulcrum pole and the second fulcrum pole;

Δh1 represents an infinitesimal displacement of the height h;

Δh2 represents an infinitesimal displacement of the hinge joint point of the first fulcrum pole and the second fulcrum pole;

Δs represents an infinitesimal displacement of the lower end of the second fulcrum pole 25 along the horizontal direction;

M1 represents a patient's load;

M2 represents a weight of the table body 1;

M3 represents a weight of the first fulcrum pole 24; and

M4 represents a weight of the second fulcrum pole 25.

Specifically, when the scanning table has a structure of the fifth embodiment, the patient's weight may be obtained by computation as follows.

α may be obtained according to Equation (10):

$$α = arcsin \frac{H}{L} \qquad Equation ( 10 )$$

F1 may be obtained according to Equation (11):

F1−(M1+M2)×9.8 Equation (11)

F2 may be obtained according to Equation (12):

F2−(M3+M4)×9.8 Equation (12)

According to the principle of virtual work in the rigid body system in structural mechanics, a work balance equation may be expressed as follows:

$$\begin{matrix}F 1 \times Δ h 1 + F 2 \times Δ h 2 = F 0 \times Δ s \\ Where & Equation ( 13 ) \\ \begin{matrix}Δ h 1 = L sin ( a + Δα ) - L sin ( α ) \\ = 2 L cos ( α + Δα \text{/} 2 ) \times sin ( Δ α \text{/} 2 )\end{matrix} \\ Similarly , & Equation ( 14 ) \\ \begin{matrix}Δ h 2 = \frac{1}{2} sin ( α + Δα ) - \frac{L}{2} sin ( α ) \\ = L cos ( α + Δ α \text{/} 2 ) \times sin ( Δ α \text{/} 2 )\end{matrix} & Equation ( 15 )\end{matrix}$$

Accordingly, Equations (16) and (17) are obtained:

Δh1=2Δh2 Equation (16)

Δs=L cos(α+Δα)−L cos(α) Equation (17)

Taking the equations (14), (15), (16) and (17) into the work balance equation (13), Equation (18) is obtained:

$$F 1 \times Δ h 1 + F 2 \times \frac{Δ h 1}{2} = F 0 \times Δ s \\ ( F 2 + F 1 ) \times Δ h 1 = F 0 \times Δ s \qquad Equation ( 18 )$$

Equation (18) is simplified to obtain:

$$\begin{matrix} ( F 1 + \frac{F 2}{2} ) = F 0 \times tan ( α + \frac{Δ a}{2} ) \\ When & Equation ( 19 ) \\ {lim}_{Δ α - 0} ( F 1 + \frac{F 2}{2} ) = F 0 \times {lim}_{Δ α - 0} ( tan ( α + \frac{Δ α}{2} ) ) = F 0 \times tan ( α ) & Equation ( 20 ) \\ ( M 1 + M 2 + \frac{M 2 + M 4}{2} ) \times 9.8 = F 0 \times tan ( α ) \\ Then \text{:} & Equation ( 21 ) \\ M 1 = \frac{F 0 \times tan ( α )}{9.8} - \frac{M 3 + M 4}{2} - M 2 & Equation ( 22 ) \\ M 1 = \frac{F 0 \times tan ( arcsin \frac{H}{L} )}{9.8} - \frac{M 3 + M 4}{2} - M 2 & Equation ( 23 )\end{matrix}$$

In some embodiment, the scanning table may be provided with a cord-pull sensor 28, so as to measure a height change of the scanning table. Referring to FIG. 14 and FIG. 15, the cord-pull sensor 28 may be mounted at one end of the scanning table, and a photoelectric encoder 27 may be mounted at the hinge joint point of the second fulcrum pole 25 and the bed base 10, so as to measure a height change and a related angle change of the scanning table, respectively.

Referring to FIG. 17, in process of computation, a digital signal measured by the photoelectric encoder 27, the cord-pull sensor 28 and the force-measuring component 3 is transmitted to the computation device 1. Corresponding values a and F0 may be obtained by the computation device 1 through conversion. The two values are further transmitted to the computation device 2. After the computation device 2 obtains related data, the patient's load M1 may be obtained according to Equations 10-23 as described above, which is then transmitted to the display 9 for displaying. The patient's load M1 may also be transmitted to a controller for further use.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

We claim:

1. A scanning table, comprising:
a table body, for supporting a human body;
a lifting system, for driving the table body to go up and down; and
a force-measuring component connected with the lifting system, for measuring a support force on the table body by the lifting system.

2. The scanning table according to claim 1, wherein the scanning table further comprises a bed base, and the lifting system comprises a first swinging pole, a second swinging pole and a driving support pole,
wherein one end of both the first swinging pole and the second swinging pole are hinged to the table body, the first swinging pole and the second swinging pole are disposed in parallel, the other end of both the first swinging pole and the second swinging pole are fixedly connected with the bed base, a telescopic end of the driving support pole is hinged to one of the first swinging pole and the second swinging pole, and a fixed end of the driving support pole is fixedly connected with the bed base and is connected with the force-measuring component.

3. The scanning table according to claim 2, wherein the force-measuring component is a hinge-pin force transducer which is hinged to the fixed end of the driving support pole, wherein the hinge-pin force transducer comprises a strain gauge, the axis line of the driving support pole is perpendicular to the strain gauge, and a hinge pin of the force-measuring component can be driven to rotate with the swinging of the driving support pole.

4. The scanning table according to claim 3, wherein the scanning table further comprises an U-shaped groove and a base disposed on the bed base, wherein the fixed end of the driving support pole is engaged to the U-shaped groove, so that the U-shaped groove is stuck to the driving support pole; the base and the U-shaped groove are provided with a first pin hole and a second pin hole, respectively, wherein the hinge pin of the force-measuring component extends through the driving support pole, the first pin hole and the second pin hole, and is fixedly connected with the U-shaped groove.

5. The scanning table according to claim 4, wherein the scanning table further comprises a clamp disposed on each side of the U-shaped groove, and each side of the hinge pin of the force-measuring component is provided with a bayonet, wherein the clamp is jammed in the bayonet.

6. The scanning table according to claim 2, wherein the force-measuring component is a cantilever force transducer or a S-shaped force transducer, which is hinged to the fixed end of the driving support pole, wherein both the cantilever force transducer and the S-shaped force transducer comprise a strain gauge, and the axis line of the driving support pole is perpendicular to the strain gauge of the force-measuring component.

7. The scanning table according to claim 6, wherein the force-measuring component is hinged to the driving support pole through a pole-end-bearing.

8. The scanning table according to claim 2, wherein the force-measuring component is a strain gauge which is disposed integrated with the driving support pole.

9. The scanning table according to claim 1, wherein the scanning table comprises a bed base and a lifting system comprising a first fulcrum pole, a second fulcrum pole and a driving lead screw, wherein the first fulcrum pole is hinged crosswise to the second fulcrum pole, one end of both the first fulcrum pole and the second fulcrum pole are hinged to the bed base, one of the other end of the first fulcrum pole and the second fulcrum pole is connected with the driving lead screw through screw connection, the remaining end of the first fulcrum pole or the second fulcrum pole is connected fixedly with the bed base, and the driving lead screw is connected with the force-measuring component.

10. The scanning table according to claim 1, wherein the scanning table further comprises a transmitter communicatively connected to the force-measuring component and a display communicatively connected to the transmitter.

11. The scanning table according to claim 10, wherein the scanning table further comprises a computation device, wherein the computation device is communicatively connected with the force-measuring component, so that a patient's weight can be calculated according to a support force measured by the force-measuring component, and the computation device is communicatively connected with the display.

12. The scanning table according to claim 2, wherein the scanning table further comprises a transmitter communicatively connected to the force-measuring component and a display communicatively connected to the transmitter.

13. The scanning table according to claim 3, wherein the scanning table further comprises a transmitter communicatively connected to the force-measuring component and a display communicatively connected to the transmitter.

14. The scanning table according to claim 4, wherein the scanning table further comprises a transmitter communicatively connected to the force-measuring component and a display communicatively connected to the transmitter.

15. The scanning table according to claim 5, wherein the scanning table further comprises a transmitter communicatively connected to the force-measuring component and a display communicatively connected to the transmitter.

16. The scanning table according to claim 6, wherein the scanning table further comprises a transmitter communicatively connected to the force-measuring component and a display communicatively connected to the transmitter.

17. The scanning table according to claim 7, wherein the scanning table further comprises a transmitter communicatively connected to the force-measuring component and a display communicatively connected to the transmitter.

18. The scanning table according to claim 8, wherein the scanning table further comprises a transmitter communicatively connected to the force-measuring component and a display communicatively connected to the transmitter.

19. The scanning table according to claim 9, wherein the scanning table further comprises a transmitter communicatively connected to the force-measuring component and a display communicatively connected to the transmitter.
